(19) United States
(12) Patent Application Publication
(10) Pub. No.: US 2011/0246209 A1
(43) Pub. Date: Oct. 6, 2011

(54) METHOD AND SYSTEM FOR PREDICTING CUSTOMER FLOW AND ARRIVAL TIMES USING POSITIONAL TRACKING OF MOBILE DEVICES

(75) Inventors: Sridhar Jagannathan, Los Altos, CA (US); Terry Hicks, San Mateo, CA (US)

(73) Assignee: Intuit Inc.

(21) Appl. No.: 12/750,926

(22) Filed: Mar. 31, 2010

(51) Int. Cl. G06Q 10/00

(52) U.S. Cl. 705/1.1

(57) ABSTRACT

A method and system for predicting customer flow and arrival times using positional tracking of mobile devices whereby data associated with one or more participating businesses is obtained including, but not limited to, the business name and the business location. The positions of one or more mobile devices associated with one or more consumers are tracked and an estimated direction/path and speed of the one or more consumers is thereby determined. A probability that the one or more consumers will utilize a particular participating business and/or products/services associated with a participating business, is then determined and the estimated arrival times at the particular participating business of consumers deemed probable to utilize the particular participating business is calculated. Data representing the number of consumers deemed probable to utilize the particular participating business and/or the estimated arrival times at the particular participating business of consumers deemed probable to utilize the particular participating business is then provided to the particular participating business.

### BACKGROUND

A significant on-going issue for many small and large businesses alike is how to accurately predict the flow of customer traffic in order to more efficiently and effectively staff the businesses and to ensure sufficient inventory is on hand to meet fluctuating customer demand. This is particularly true of service based businesses and is even more critical for businesses that have perishable inventory, such food service related businesses.

Currently, a given business owner must estimate customer flow largely using historical data, and/or common sense, and/or guess work, and/or trial and error. Then, currently, the business owner must try to strike a balance between ensuring staffing and inventory is ready for a best case scenario, i.e., the maximum flow of customers, and a worst case scenario, i.e., a minimum flow of customers. While historical data can be used quite effectively for predictive purposes, historical data often does not, and can not by definition, take into account unexpected or randomly occurring events. In addition, a new business often has little, or no, historical data to draw on. Consequently, historical analysis has significant limits of use and, as a result, currently, the estimates made by business owners often prove inaccurate with the result that either customer service suffers or the business owner incurs unnecessary overhead in the form of over staffing costs and/or wasted inventory costs.

For instance, as a specific illustrative example, an owner of a pizza shop must decide how many workers to pay to work the kitchen, order counter, and cash register at a given time and how many pizza's, and/or other items, to have pre-prepared and available for sale at a given time. In this specific illustrative example, if the pizza shop owner under estimates customer flow, then customers can be forced to wait in long lines and/or for long periods of time for their food. This, in turn, effects customer satisfaction and ultimately may cost the business both immediate sales, as potential customers simply give up and leave, and future sales, as customers avoid using the business because they remember the long wait times, and/or as the long wait time problem is spread by word of mouth and/or by one or more review forums to other potential customers.

On the other hand, in this specific illustrative example, if the pizza shop owner over estimates customer flow, the pizza shop owner is forced to pay for employee time that is not needed and there is a potential for wasted inventory as pre-prepared pizzas, and/or other perishable items, are not sold and the cost of acquiring and preparing these items is not recouped.

As noted, the situation described above is problematic for small and large businesses alike, however, small businesses, already under considerable pressure in the current economic environment, are often particularly hard hit by inaccurate customer flow estimates. This is because small businesses often do not have the large infrastructure, the diversity of products and sites, and the volume of business required to offset the losses incurred in a given period and at a given location due inaccurate estimation of customer traffic flow and volume.

In addition, customers often suffer under the situation described above as they are forced to waste time waiting for products and/or services and, at times, are denied the opportunity to obtain the products and/or services they desire. Consequently, the current inability of businesses to accurately predict customer flow is disadvantageous for both businesses and customers alike.

### SUMMARY

In accordance with one embodiment, a method and system for predicting customer flow and arrival times using positional tracking of mobile devices includes a process for predicting customer flow and arrival times using positional tracking of mobile devices whereby, in one embodiment, data associated with one or more participating businesses is obtained including, but not limited to, data indicating one or more of: the business name; the business location; and/or products/services provided by the business. In one embodiment, the positions of one or more mobile devices associated with one or more consumers are then tracked and an estimated direction/path and speed of the one or more consumers is thereby determined. In one embodiment, a probability that the one or more consumers will utilize a particular participating business, and/or specific products and/or services associated with a particular participating business, is then determined for each of the one or more consumers based, at least in part on, but not limited to, one or more of the following probability of use parameters: how close the estimated direction/path of a consumer brings the consumer to the particular participating business; generalized consumer usage data; the time of day, day of the week, or date; personalized consumer usage data such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for predicting customer flow and arrival times using positional tracking of mobile devices and/or one or more participating businesses. In one embodiment, the estimated arrival times at the particular participating business of consumers deemed probable to utilize the particular participating business is then calculated, and/or updated, using the tracked positions of the one or more mobile devices associated with the consumers deemed probable to utilize the particular participating business and the estimated direction/path and speed of the consumers deemed probable to utilize the particular participating business. In one embodiment, data representing the number of consumers deemed probable to utilize the particular participating business and/or the estimated arrival times at the particular participating business of consumers deemed probable to utilize the particular participating business is then provided to the particular participating business.

Using the method and system for predicting customer flow and arrival times using positional tracking of mobile devices discussed herein, a business owner is provided the information to more accurately predict the flow of customer traffic in relative real time based on actual potential customer positions, predicted customer paths and movement, and a calculated probability of potential customer patronage. Consequently, using the method and system for predicting customer flow and arrival times using positional tracking of mobile devices, as discussed herein, the business owner can more efficiently and effectively staff the businesses and ensure sufficient inventory is on hand to meet fluctuating customer demand. As a result, both businesses and consumers are directly benefited by use of the method and system for predicting customer flow and arrival times using positional tracking of mobile devices discussed herein.

### BRIEF DESCRIPTION OF THE DRAWINGS

FIG. 1 is a block diagram of an exemplary hardware architecture for implementing one embodiment including “N” mobile computing systems connected to a mobile communication network, and a provider computing system, a merchant computing, and a database, connected by a network in accordance with one embodiment;

FIG. 2 is a block diagram of a exemplary memory system associated with the provider computing system of FIG. 1, in accordance with one embodiment; and

FIG. 3 is a flow chart depicting one embodiment of a process for predicting customer flow and arrival times using positional tracking of mobile devices in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. The following description includes reference to specific embodiments for illustrative purposes. However, the illustrative discussion below is not intended to be exhaustive or to limit the invention to the precise forms disclosed. Many modifications and variations are possible in view of the teachings below. The embodiments discussed below were chosen and described in order to explain the principles of the invention, and its practical applications, to thereby enable others skilled in the art to utilize the invention and various embodiments with various modifications as may be suited to the particular use contemplated. Therefore, embodiments may be embodied in many different forms than those shown and discussed herein and should not be construed as limited to the embodiments set forth herein, shown in the FIG.s, and/or described below.

In accordance with one embodiment, a method and system for predicting customer flow and arrival times using positional tracking of mobile devices includes a process for predicting customer flow and arrival times using positional tracking of mobile devices whereby, in one embodiment, data associated with one or more participating businesses is obtained including, but not limited to, data indicating one or more of: the business name; the business location; and/or products/services provided by the business. In one embodiment, the positions of one or more mobile devices associated with one or more consumers are tracked and an estimated direction/path and speed of the one or more consumers is thereby determined. In one embodiment, a probability that the one or more consumers will utilize a particular participating business, and/or specific products and/or services associated with a participating business, is then determined for each of the one or more consumers based, at least in part on, but not limited to, one or more of the following probability of use parameters: how close the estimated direction/path of a consumer brings the consumer to the particular participating business; generalized consumer usage data; the time of day, day of the week, or date; personalized consumer usage such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for predicting customer flow and arrival times using positional tracking of mobile devices and/or one or more participating businesses. In one embodiment, the estimated arrival times at the particular participating business of consumers deemed probable to utilize the particular participating business is then calculated, and/or updated, using the tracked positions of the one or more mobile devices associated with the consumers deemed probable to utilize the particular participating business and the estimated direction/path and speed of the consumers deemed probable to utilize the particular participating business. In one embodiment, data representing the number of consumers deemed probable to utilize the particular participating business and/or the estimated arrival times at the particular participating business of consumers deemed probable to utilize the particular participating business is then provided to the particular participating business.

In accordance with one embodiment, one or more participating businesses are registered with and/or subscribe to the process for predicting customer flow and arrival times using positional tracking of mobile devices. In one embodiment, as part of the subscription/registration process, the one or more participating businesses provide the process for predicting customer flow and arrival times using positional tracking of mobile devices various business related data including, but not limited to, one or more of data indicating: the participating business name; the participating business location; products/services provided by the participating business; the participating business hours of operation; various logistical data associated with the participating business such as parking availability, seating capacity, etc.; and/or any other data associated with the participating business desired by the provider of the process for predicting customer flow and arrival times using positional tracking of mobile devices and/or one or more businesses.

Herein, the terms “business”, “merchant” and “user” are used interchangeably and include, but are not limited to, providers of goods and services, and other advertisers, and/or any party and/or entity that interfaces with, and/or to whom information is provided by, a process for predicting customer flow and arrival times using positional tracking of mobile devices, and/or a person and/or entity that interfaces with, and/or to whom information is provided by, a process for predicting customer flow and arrival times using positional tracking of mobile devices, and/or any authorized agent of any party and/or person and/or entity that interfaces with, and/or to whom information is provided by, a process for predicting customer flow and arrival times using positional tracking of mobile devices.

In one embodiment, a participating business provides their business related data via one or more user interface screens displayed on one or more display devices associated with one or more merchant computing systems that are controlled by, accessible by, or otherwise associated with the participating business, a participating business owner, a participating business employee, or any agent for the participating business. In one embodiment, the one or more participating businesses provide their business related data via one or more merchant computing systems and/or a user interface device such as a keyboard, mouse, touchpad, voice command recognition system, or any other device capable of providing user input to a computing system or for translating user actions into computing system operations, whether available or known at the time of filing or as developed later.

As used herein, the term “computing system”, includes, but is not limited to: a desktop computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

In one embodiment, the business related data associated with each of the participating businesses is obtained by the process for predicting customer flow and arrival times using positional tracking of mobile devices via any network or network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or as available or known at the time of filing, and/or as later developed.

In one embodiment, the business related data associated with each of the participating businesses is obtained by the process for predicting customer flow and arrival times using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, the business related data associated with each of the participating businesses is obtained by the process for predicting customer flow and arrival times using positional tracking of mobile devices and the data is then stored in a participating business database.

As used herein, the term “database” includes any data storage mechanism known at the time of filing or as developed thereafter, such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In one embodiment, the positions of one or more mobile devices associated with one or more consumers are tracked. In one embodiment, the one or more mobile devices associated with one or more consumers are registered with the process for predicting customer flow and arrival times using positional tracking of mobile devices by any method, means, mechanism or procedure for registering a computing system and/or device, as discussed herein, and/or available or known at the time of filing, and/or as developed after the time of filing. In one embodiment, the one or more mobile devices associated with one or more consumers are not specifically registered with the process for predicting customer flow and arrival times using positional tracking of mobile devices, but are tracked by the process for predicting customer flow and arrival times using positional tracking of mobile devices through one or more mobile communication networks.

Herein, the term “mobile device” includes, but is not limited to: a mobile “computing system”; a portable computer; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device and/or computing system that includes components that can execute all, or part, of any one of the processes and/or operations as described herein. In addition, as used herein, the term mobile device, can denote, but is not limited to, computing systems made up of multiple: wireless devices; cellular telephones; digital telephones; two-way pagers; PDAs; media players; or any desired combination of these devices and/or computing systems, that are coupled to perform the processes and/or operations as described herein.

In one embodiment, the one or more mobile devices are connected by one or more mobile communication networks such as, but not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more computing systems, as discussed herein, and/or available or known at the time of filing, and/or as developed after the time of filing.

In one embodiment, the positions of one or more mobile devices associated with one or more consumers are tracked by obtaining data regarding the position of the one or more mobile devices at two or more times and then using the data regarding the position of the one or more mobile devices at two or more times to calculate an estimated direction/path and speed of the one or more consumers using one or more processors associated with one or more computing systems. In one embodiment, the positions of one or more mobile devices associated with one or more consumers are tracked by obtaining data regarding the position of the one or more mobile devices at regular intervals, such as every second, every few seconds, every minute, every few minutes, etc. and then estimating, and updating and/or refining the estimated direction/path and speed of the one or more consumers accordingly using one or more processors associated with one or more computing systems.

In various embodiments, one or more of the one or more mobile devices are associated with consumers traveling by car, bicycle, train, bus, or any other vehicle in an relatively open environment, such as outside, or in a relatively closed environment, such as a mall, stadium, or shopping center. In various embodiments, one or more of the one or more mobile devices are associated with consumers traveling by foot in a relatively open environment, such as outside, or in a relatively closed environment, such as a mall, stadium, or shopping center.

In various embodiments, the position of the one or more mobile devices is determined based on analysis of a communication signal emitted by the mobile devices and/or the relay stations used by the mobile devices. In various embodiments, the position of the one or more mobile devices is determined using a Global Positioning Satellite (GPS) system and/or a GPS capability provided with the one or more mobile devices. In various embodiments, the position of the one or more mobile devices is provided by the one or more mobile devices themselves via one or more data links. In various embodiments, the position of the one or more mobile devices is determined and/or provided by any method, means, mechanism, or procedure for determining a position of a mobile device as discussed herein, and/or as known in the art at the time of filing, and/or as developed after the time of filing.

Numerous means, methods, equations, algorithms, procedures and processes are known in the art for calculating an estimated direction/path and speed using two or more positions taken at different times. Consequently, a more detailed discussion of any particular means, methods, equations, algorithms, procedures and processes for calculating an estimated direction/path and speed of one or more consumers using two or more positions taken at different times is omitted here to avoid detracting from the invention.

As noted above, in one embodiment, the data regarding the position of the one or more mobile devices at two or more times is used to calculate, and/or update, an estimated direction/path and speed of the one or more consumers. In one embodiment, the data regarding the position of the one or more mobile devices at two or more times is used to calculate, and/or update, an estimated direction/path and speed of the one or more consumers and then the estimated direction/path for a given customer is modified based on data particular to the customer such as data obtained from a customer's calendar application, in one embodiment as implemented on the mobile device, indicating a time and place of a meeting. In one embodiment this calendar data is then used to refine the estimated direction/path and speed for the given customer based on where the customer needs to be at a given time.

In one embodiment, the business related data associated with each of the participating businesses, as stored in one embodiment in a participating business database, is searched to determine which participating businesses are within a defined distance of the estimated direction/path of the of the one or more mobile devices, and therefore of the one or more consumers associated with the one or more mobile devices. In one embodiment, a probability of a particular consumer passing within a defined distance of a particular participating business is calculated for each consumer/participating business pairing.

In one embodiment, a probability that one or more of the one or more consumers will utilize a particular participating business is then determined. In one embodiment, a probability that one or more of the one or more consumers will utilize a particular participating business is determined based, at least in part, on one or more probability of use parameters.

In one embodiment, the probability that one or more of the one or more consumers will utilize a particular participating business is determined based, at least in part, on a proximity probability of use parameter indicating how close the estimated direction/path of a consumer brings the consumer to a particular participating business. In one embodiment, the closer the estimated direction/path of a consumer brings the consumer to a particular participating business, the greater the probability that the consumer will utilize the particular participating business.

For instance, as a specific illustrative example, if it is determined that the estimated direction/path of a consumer brings the consumer within 100 yards of a Starbucks coffeehouse, then the probability that the consumer will utilize the Starbucks coffeehouse, i.e., purchase a product sold by the Starbucks coffeehouse, would be considered higher than if the estimated direction/path of a consumer brings the consumer within between 100 yards and 1000 yards of a Starbucks coffeehouse.

In one embodiment, the probability that one or more of the one or more consumers will utilize a particular participating business is determined based, at least in part, on a proximity probability of use parameter and generalized statistical consumer usage data such as data indicating, on average, what percentage of consumers who pass by a given business type offering products and/or services similar to a particular participating business are statistically likely to utilize the given business type.

For instance, as a specific illustrative example, if it is determined that the estimated direction/path of a consumer brings the consumer within 100 yards of a Starbucks coffeehouse, and statistics show that, on average, 5% of consumers who see a Starbucks coffeehouse utilize the Starbucks coffeehouse, then this data is used to help determine the probability that a consumer will utilize the Starbucks coffeehouse.

In one embodiment, the probability that one or more of the one or more consumers will utilize a particular participating business is determined based, at least in part, on a proximity probability of use parameter and generalized statistical consumer usage data modified based on time of the time of day, day of the week, or date.

For instance, as a specific illustrative example, if it is determined that the estimated direction/path of a consumer, traveling at a determined/estimated speed, brings the consumer within 100 yards of a Starbucks coffeehouse, and statistics show that, on average, 15% of consumers who see a Starbucks coffeehouse utilize the Starbucks coffeehouse between the hours of 6:00 AM and 10:00 AM while, on average, only 1% of consumers who see a Starbucks coffeehouse utilize the Starbucks coffeehouse between the hours of 10 AM and 10 PM, then this data, along with data indicating the local time of day, is used to help determine the probability that a consumer will utilize the Starbucks coffeehouse.

In one embodiment, the probability that one or more of the one or more consumers will utilize a particular participating business is determined based, at least in part, on a proximity probability of use parameter and personalized probability of use parameters. In one embodiment, the probability that one or more of the one or more consumers will utilize a particular participating business is extended to the probability of consumption of certain products within that business. As an example, specific and distinct consumption probabilities can be computed for consumption of specific edibles at Starbucks, knowing the probability of visiting Starbucks, the time of day, the customer's past patterns of consumptions, the weather, the time taken to provide the edible and so on. Thus one embodiment anticipates creating consumption probabilities for Croissants, for Cappuccino, etc. at a Starbucks in the trajectory of customers.

In one embodiment, the personalized probability of use parameters are derived from data specific to a given consumer such as, but not limited to, data obtained from a consumer's calendar application, in one embodiment as implemented and/or accessed on the mobile device, indicating a time and place of a meeting and/or whether the customer has historically utilized the particular participating business, or businesses offering products and/or services similar to the products and/or services offered by the particular participating business, and/or if the consumer has time to utilize a particular participating business.

In one embodiment, the personalized probability of use parameters are derived from data specific to a given consumer such as, but not limited to, financial transaction data from one or more financial management systems and/or on-line banking systems, in one embodiment as implemented and/or accessed on the mobile device, indicating whether the consumer has historically utilized the particular participating business, or businesses offering products and/or services similar to the products and/or services offered by the particular participating business, and/or if the consumer has a preference for one or another business of businesses offering similar products and/or services, such as a preference for Starbucks coffee over Peet's coffee.

In one embodiment, the personalized probability of use parameters are derived from data specific to a given consumer such as, but not limited to, financial transaction data from one or more financial management systems and/or on-line banking systems, in one embodiment as implemented and/or accessed on the mobile device, indicating whether the consumer has historically utilized the particular participating business, or businesses offering products and/or services similar to the products and/or services offered by the particular participating business at the determined time of day, day of the week, or date.

In one embodiment, the personalized probability of use parameters are derived from data specific to a given consumer such as, but not limited to, historical positional data associated with the mobile device and the consumer, in one embodiment as implemented and/or accessed and/or stored on the mobile device, indicating whether the consumer has historically utilized the particular participating business, or businesses offering products and/or services similar to the products and/or services offered by the particular participating business.

In one embodiment, the personalized probability of use parameters are derived from data specific to a given consumer such as, but not limited to, historical positional data associated with the mobile device and the consumer, in one embodiment as implemented and/or accessed and/or stored on the mobile device, indicating whether the consumer has historically utilized the particular participating business, or businesses offering products and/or services similar to the products and/or services offered by the particular participating business at the determined time of day, day of the week, or date; and/or any other data specific to a given consumer defined by the process for predicting customer flow and arrival times using positional tracking of mobile devices and/or one or more participating businesses.

In one embodiment, any of the probability of use parameters, or combination of probability of use parameters, discussed above, or any other probability of use parameters defined by the process for predicting customer flow and arrival times using positional tracking of mobile devices and/or one or more participating businesses, are used to determine, and/or refine, a probability that one or more of the one or more consumers will utilize a particular participating business.

Numerous means, methods, equations, algorithms, procedures and processes are known in the art for calculating probabilities and probability functions based on one or more parameters and/or variables. Consequently, a more detailed discussion of any particular means, methods, equations, algorithms, procedures and processes for determining the probability that one or more of the one or more consumers will utilize a particular participating business using one of more probability of use parameters is omitted here to avoid detracting from the invention.

In one embodiment, a probability score is calculated for each participating business/consumer pair that indicates a probability that a particular consumer will utilize a particular participating business in a defined time frame.

In one embodiment, a threshold probability score is defined for each participating business such that any consumer having a probability score associated with a particular participating business that is greater than the defined threshold probability score is deemed probable to utilize the particular participating business. For instance, as a specific illustrative example, a threshold probability score of 34% may be defined for a particular Starbucks coffeehouse. Then any consumer having a probability score of 34% or greater is determined to be a probable customer of the particular Starbucks coffeehouse.

In various embodiments, a given consumer is deemed probable to utilize the particular participating business using any other criteria as discussed herein, and/or as known in the art at the time of filing, and/or as developed after the time of filing.

In various embodiments, all tracked consumers are deemed probable to utilize the particular participating business, albeit with a wide range of probabilities extending from very low to relatively high. In various embodiments, any desired sub-set of tracked consumers are deemed probable to utilize the particular participating business.

As noted above, in one embodiment, the data regarding the position of the one or more mobile devices, and, in some embodiments, various data specific to a given consumer, is used to calculate, and/or update, an estimated direction/path and speed for the one or more consumers. In one embodiment, the estimated direction/path and speed for the one or more consumers is used to calculate, and/or update, estimated arrival times of one or more of the one or more consumers at the particular participating business. In one embodiment, the estimated direction/path and speed for the one or more consumers is used to calculate, and/or update, estimated arrival times of only those consumers deemed probable to utilize the particular participating business at the particular participating business.

In one embodiment, data representing the number of consumers deemed probable to utilize the particular participating business and/or the estimated arrival times at the particular participating business of consumers deemed probable to utilize the particular participating business is then provided to the particular participating business.

In one embodiment, data representing the number of consumers deemed probable to utilize the particular participating business and/or the estimated arrival times at the particular participating business of consumers deemed probable to utilize the particular participating business is then provided to the particular participating business on a relative, i.e., almost, real time basis.

In one embodiment, data representing the number of individual consumers deemed probable to utilize the particular participating business and/or the estimated arrival times at the particular participating business of the individual consumers deemed probable to utilize the particular participating business is aggregated using a probabilistic approach to predict customer flow/loading for the participating business in a defined time frame.

In one embodiment, a probability score is calculated for the predicted customer flow/loading for the participating business in a defined time frame.

In one embodiment, data representing the number of consumers deemed probable to utilize the particular participating business and/or the estimated arrival times at the particular participating business of consumers deemed probable to utilize the particular participating business is then provided to the particular participating business via any data link as discussed herein, and/or as known in the art at the time of filing, and/or as developed after the time of filing.

In one embodiment, data representing the number of consumers deemed probable to utilize the particular participating business and/or the estimated arrival times at the particular participating business of consumers deemed probable to utilize the particular participating business is then provided to the particular participating business through one or more merchant computing systems as discussed herein, and/or as known in the art at the time of filing, and/or as developed after the time of filing.

In one embodiment, data representing the number of consumers deemed probable to utilize the particular participating business and/or the estimated arrival times at the particular participating business of consumers deemed probable to utilize the particular participating business is then provided to the particular participating business through one or more databases, as discussed herein, and/or as known in the art at the time of filing, and/or as developed after the time of filing.

In one embodiment, data representing the number of consumers deemed probable to utilize the particular participating business and/or the estimated arrival times at the particular participating business of consumers deemed probable to utilize the particular participating business is then provided to the particular participating business through one or more networks, as discussed herein, and/or as known in the art at the time of filing, and/or as developed after the time of filing.

In one embodiment, data representing the number of consumers deemed probable to utilize the particular participating business and/or the estimated arrival times at the particular participating business of consumers deemed probable to utilize the particular participating business is then provided to the particular participating business using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

### Hardware Architecture

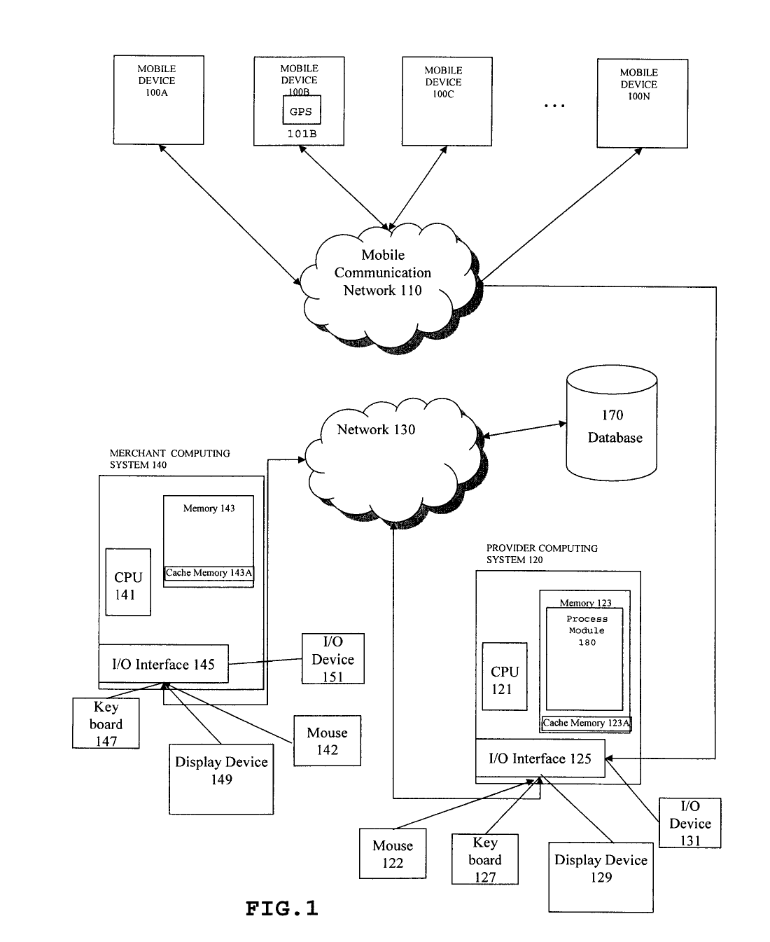

FIG. 1 is a block diagram of an exemplary hardware architecture for implementing one embodiment of a system and method for predicting customer flow and arrival times using positional tracking of mobile devices, such as exemplary process 300 discussed herein, that includes: “N” mobile devices 100A, 100B, 100C, . . . 100N, e.g., mobile “computing systems”; a mobile communication network 110; a provider computing system 120, e.g. a first computing system; a merchant mobile computing system 140, e.g. a second computing system; and a database 170, all operatively coupled by a network 130.

As noted above, herein, the term “mobile device”, as used in the term mobile devices 100A through 100N, includes, but is not limited to: a mobile “computing system”; a portable computer; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device and/or computing system that includes components that can execute all, or part, of any one of the processes and/or operations as described herein. In addition, as used herein, the term mobile device, can denote, but is not limited to, computing systems made up of multiple: wireless devices; cellular telephones; digital telephones; two-way pagers; PDAs; media players; or any desired combination of these devices and/or computing systems, that are coupled to perform the processes and/or operations as described herein.

In various embodiments, mobile devices 100A through 100N are associated with one or more consumers. As also seen in FIG. 1, in various embodiments, one or mobile devices 100A through 100N include positional capabilities, such as illustrative GPS 101B shown as being associated with mobile device 100B.

As also shown in FIG. 1, in one embodiment, mobile devices 100A through 100N are connected by mobile communication network 110. In various embodiments, mobile communication network 110 is representative of multiple mobile communication networks.

As noted above, in various embodiments, mobile communication network 110 can be, but is not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more mobile devices and/or computing systems, as discussed herein, and/or available or known at the time of filing, and/or as developed after the time of filing.

Also shown in FIG. 1 is provider computing system 120. In various embodiments, provider computing system 120 is under the control of, accessible by, or otherwise associated with, a provider of process for predicting customer flow and arrival times using positional tracking of mobile devices and is used to implement at least part of a process for predicting customer flow and arrival times using positional tracking of mobile devices.

As shown in FIG. 1, provider computing system 120 typically includes a central processing unit (CPU) 121, an input/output (I/O) interface 125, and a memory system 123, including cache memory 123A. In one embodiment, memory system 123 includes all, or part of, a process module 180 for implementing at least part of a process for predicting customer flow and arrival times using positional tracking of mobile devices, such as exemplary process 300 discussed below.

Provider computing system 120 may further include standard user interface devices such as a keyboard 127, a mouse 122, and a display device 129, as well as, one or more standard input/output (I/O) devices 131, such as a compact disk (CD) or Digital Video Disc (DVD) drive, floppy disk drive, or other digital or waveform port, or other device capable of inputting data to, and outputting data from, provider computing system 120, whether available or known at the time of filing or as later developed.

In one embodiment, all, or part of: a process for predicting customer flow and arrival times using positional tracking of mobile devices; business data associated with one or more participating businesses; data representing one or more estimated consumer paths and speeds; and/or various analysis data associated with process for predicting customer flow and arrival times using positional tracking of mobile devices is stored, in whole, or in part, in memory 123 of provider computing system 120.

In one embodiment, all, or part of: a process for predicting customer flow and arrival times using positional tracking of mobile devices; business data associated with one or more participating businesses; data representing one or more estimated consumer paths and speeds; and/or various analysis data associated with process for predicting customer flow and arrival times using positional tracking of mobile devices is/are entered, in whole, or in part, into provider computing system 120 via I/O device 131, such as from a CD, DVD, floppy disk, portable hard drive, memory stick, download site, or other medium and/or computer program product as defined herein.

As noted above, as used herein, the term “computing system” includes, but is not limited to: a desktop computing system/computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

In one embodiment, provider computing system 120 is representative of two or more computing systems. In one embodiment, provider computing system 120 is a client computing system associated with one or more server computing systems. In one embodiment, provider computing system 120 is a server computing system that is, in turn, associated with one or more client computing systems. In one embodiment, provider computing system 120 is part of a cloud computing environment.

In one embodiment, provider computing system 120 is operatively coupled to mobile communication network 110, and/or a provider of mobile communication network 110, such that provider computing system 120 can obtain position data associated with one or more of mobile computing systems 100A through 100N.

As also seen in FIG. 1, in one embodiment, merchant computing system 140 can include a CPU 141, an input/output (I/O) interface 145, and a memory system 143, including cache memory 143A. In one embodiment, merchant computing system 140 may further include standard user interface devices such as a keyboard 147, a mouse 142, and a display device 149, as well as, one or more standard input/output (I/O) devices 151, such as a compact disk (CD) or DVD drive, floppy disk drive, or other digital or waveform port, or other device capable of inputting data to, and outputting data from, merchant computing system 140, whether available or known at the time of filing or as later developed.

In one embodiment, merchant computing system 140 is representative of multiple computing systems. In various embodiments, merchant computing system 140 can be any computing system as defined herein, and/or as known in the art at the time of filing, and/or as developed thereafter, that includes components that can execute all, or part, of a process for predicting customer flow and arrival times using positional tracking of mobile devices in accordance with at least one of the embodiments as described herein.

Also shown in FIG. 1 is database 170. In one embodiment, database 170 is a participating business database that includes at least part of business related data associated with one or more participating businesses.

In one embodiment, database 170 is a data storage device, a designated server system or computing system, or a designated portion of one or more server systems or computing systems, such as computing system(s) 120 and/or 140, or a distributed database, or an external and/or portable hard drive. In one embodiment, database 170 is a dedicated mass storage device implemented in software, hardware, or a combination of hardware and software.

In one embodiment, database 170 is a web-based function. As discussed in more detail below, in one embodiment, database 170 is under the control of, or otherwise accessible by, a process for predicting customer flow and arrival times using positional tracking of mobile devices. In one embodiment, database 170 is part of a cloud computing environment.

In one embodiment, provider computing system 120, merchant computing system 140, and database 170, are coupled through network 130. In various embodiments, network 130 is any network, communications network, or network/communications network system such as, but not limited to: any general network, communications network, or general network/communications network system; a cellular network; a wireless network; a combination of different network types, or other wireless, wired, and/or a wireless and wired combination network; a public network; a private network; a satellite network; a cable network; or any other network capable of allowing communication between two or more computing systems, as discussed herein, and/or available or known at the time of filing, and/or as developed after the time of filing.

Those of skill in the art will readily recognize that the components shown in FIG. 1, such as mobile devices 100A through 100N, provider computing system 120, merchant computing system 140, and database 170, and their respective components, are shown for illustrative purposes only and that architectures with more or fewer components can implement, and benefit from, the invention. Moreover, one or more components of mobile devices 100A through 100N, provider computing system 120, merchant computing system 140, and database 170 may be located remotely from their respective system and accessed via network, as discussed herein. In addition, the particular type of, and configuration of, mobile devices 100A through 100N, provider computing system 120, merchant computing system 140, and database 170 are not relevant.

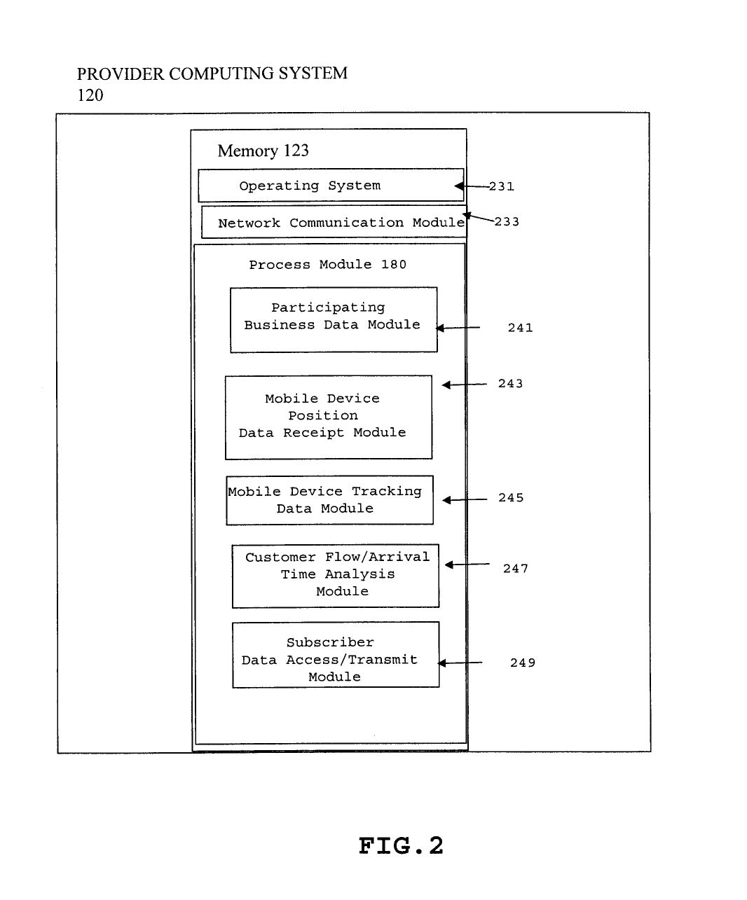

FIG. 2 is a more detailed block diagram of memory system 123 of provider computing system 120 of FIG. 1. As seen in FIG. 2, memory system 123 can store data and/or instructions associated with, but not limited to, the following elements, subsets of elements, and/or super-sets of elements for processing by one or more processors: operating system 231 that includes procedures, data, and/or instructions for handling various services and performing/coordinating hardware dependent tasks; network communications module 233 that includes procedures, data, and/or instructions, for connecting provider computing system 120 to other computing systems, such as merchant computing system 140 of FIG. 1, and/or one or more networks, such as mobile communications network 110 and/or network 130 of FIG. 1, and/or a database, such as database 170 of FIG. 1; and process module 180 that includes procedures, data, and/or instructions, associated with a process for predicting customer flow and arrival times using positional tracking of mobile devices.

As also seen in FIG. 2, process module 180 includes participating business data module 241 that includes procedures, data, and/or instructions, for obtaining and/or storing business related data associated with one or more participating busses including, but not limited to, one or more of data indicating the participating business name; the participating business location; products/services provided by the participating business; the participating business hours of operation; various logistical data associated with the participating business such as parking availability, seating capacity, etc.; and/or any other data associated with the participating business desired by the provider of the process for predicting customer flow and arrival times using positional tracking of mobile devices and/or one or more businesses.

As also seen in FIG. 2, in one embodiment, process module 180 includes mobile device position data receipt module 243 that includes procedures, data, and/or instructions, for obtaining and/or storing data indicating the positions of one or more mobile devices associated with one or more consumers at various times.

As also seen in FIG. 2, in one embodiment, process module 180 includes mobile device tracking data module 245 that includes procedures, data, and/or instructions, for determining an estimated direction/path and speed of the one or more consumers using the data indicating the positions of one or more mobile devices associated with one or more consumers at various times of mobile device position data receipt module 243.

As also seen in FIG. 2, in one embodiment, process module 180 includes customer flow/arrival time analysis mobile 247 that includes procedures, data, and/or instructions, for determining a probability that one or more of the one or more consumers will utilize a particular participating business and estimating arrival times of one or more of the one or more consumers at a particular participating business.

As also seen in FIG. 2, in one embodiment, process module 180 includes subscriber data access/transmit module 249 that includes procedures, data, and/or instructions, for providing subscribing ones of the one or more participating businesses data representing the number of consumers deemed probable to utilize the particular participating business and/or the estimated arrival times at the particular participating business of consumers deemed probable to utilize the particular participating business.

Those of skill in the art will readily recognize that the choice of components, data, modules, and information shown in FIG. 2, the organization of the components, data, modules, and information shown in FIG. 2, and the manner of storage and location of storage of the data, modules, and information shown in FIG. 2 was made for illustrative purposes only and that other choices of components, data, modules, and information, organization of the components, data, modules, and information, manner of storing, and location of storage, of the data, modules, and information can be implemented without departing from the scope of the invention as set forth in the claims below. In particular, the various modules and/or data shown in FIG. 2 are illustrative only and not limiting. In various other embodiments, the particular modules and/or data shown in FIG. 2 can be grouped together in fewer modules and/or data locations or divided among more modules and/or data locations. Consequently, those of skill in the art will recognize that other orders and/or grouping are possible and the particular modules and/or data, order, and/or grouping shown in FIG. 2 discussed herein do not limit the scope as claimed below.

### Process

In accordance with one embodiment, a method and system for predicting customer flow and arrival times using positional tracking of mobile devices includes a process for predicting customer flow and arrival times using positional tracking of mobile devices whereby, in one embodiment, data associated with one or more participating businesses is obtained including, but not limited to, data indicating one or more of: the business name; the business location; and/or products/services provided by the business. In one embodiment, the positions of one or more mobile devices associated with one or more consumers are tracked and an estimated direction/path and speed of the one or more consumers is thereby determined. In one embodiment, a probability that the one or more consumers will utilize a particular participating business is then determined for each of the one or more consumers based, at least in part on, but not limited to, one or more of the following probability of use parameters: how close the estimated direction/path of a consumer brings the consumer to the particular participating business; generalized consumer usage data; the time of day, day of the week, or date; personalized consumer usage such as whether the consumer has historically utilized the particular participating business, or businesses offering products and/or services similar to the products and/or services offered by the particular participating business, and/or whether the consumer has historically utilized the particular participating business, or businesses offering products and/or services similar to the products and/or services offered by the particular participating business, at the determined time of day, day of the week, or date; or any other probability of use parameter, or combination of probability of use parameters, defined by the process for predicting customer flow and arrival times using positional tracking of mobile devices and/or one or more participating businesses. In one embodiment, the estimated arrival times at the particular participating business of consumers deemed probable to utilize the particular participating business is then calculated, and/or updated, using the tracked positions of the one or more mobile devices associated with the consumers deemed probable to utilize the particular participating business and the estimated direction/path and speed of the consumers deemed probable to utilize the particular participating business. In one embodiment, data representing the number of consumers deemed probable to utilize the particular participating business and/or the estimated arrival times at the particular participating business of consumers deemed probable to utilize the particular participating business is then provided to the particular participating business, in one embodiment, on a relative, i.e., almost, real time basis.

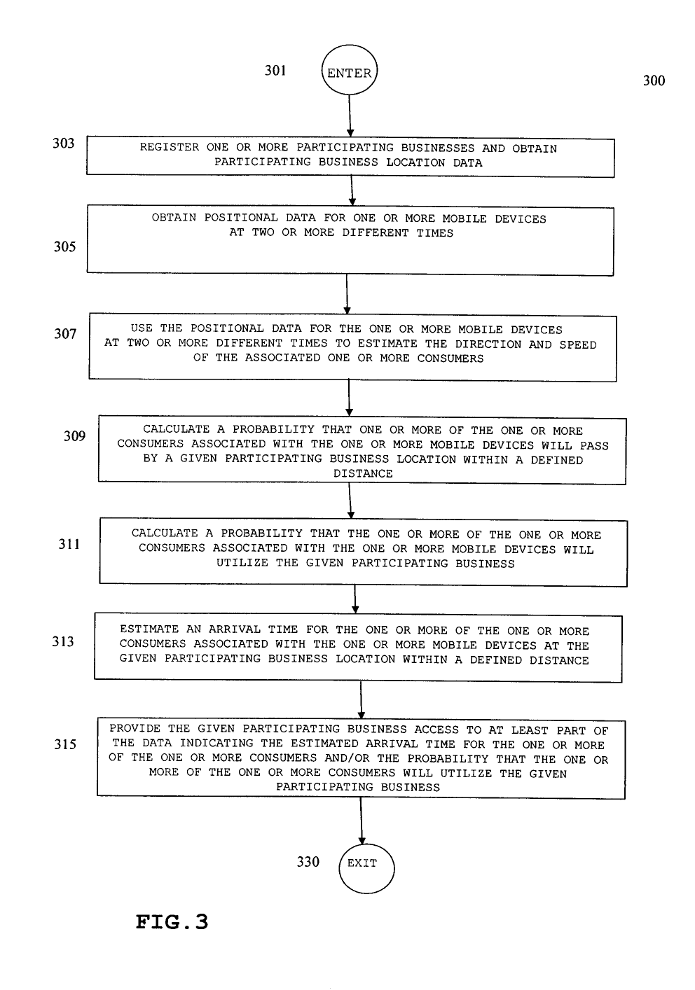

FIG. 3 is a flow chart depicting a process for predicting customer flow and arrival times using positional tracking of mobile devices 300 in accordance with one embodiment. Process for predicting customer flow and arrival times using positional tracking of mobile devices 300 begins at ENTER OPERATION 301 of FIG. 3 and process flow proceeds to REGISTER ONE OR MORE PARTICIPATING BUSINESSES AND OBTAIN PARTICIPATING BUSINESS LOCATION DATA OPERATION 303.

In one embodiment, at REGISTER ONE OR MORE PARTICIPATING BUSINESSES AND OBTAIN PARTICIPATING BUSINESS LOCATION DATA OPERATION 303 one or more participating businesses are registered with and/or subscribe to process for predicting customer flow and arrival times using positional tracking of mobile devices 300 and/or various business related data associated with one or more participating businesses is obtained by process for predicting customer flow and arrival times using positional tracking of mobile devices 300.

In one embodiment, at REGISTER ONE OR MORE PARTICIPATING BUSINESSES AND OBTAIN PARTICIPATING BUSINESS LOCATION DATA OPERATION 303 as part of the subscription/registration process, the one or more participating businesses provide process for predicting customer flow and arrival times using positional tracking of mobile devices 300 business related data including, but not limited to, one or more of data indicating: the participating business name; the participating business location; products/services provided by the participating business; the participating business hours of operation; various logistical data associated with the participating business such as parking availability, seating capacity, etc.; and/or any other data associated with the participating business desired by the provider of process for predicting customer flow and arrival times using positional tracking of mobile devices 300 and/or one or more businesses.

In one embodiment, at REGISTER ONE OR MORE PARTICIPATING BUSINESSES AND OBTAIN PARTICIPATING BUSINESS LOCATION DATA OPERATION 303 a participating business provides their business related data via one or more user interface screens displayed on one or more display devices associated with one or more merchant computing systems, such as display device 149 of merchant computing system 140 of FIG. 1, that are/is controlled by, accessible by, or otherwise associated with, the participating business, a participating business owner, a participating business employee, or any agent for the participating business.

Returning to FIG. 3, In one embodiment, at REGISTER ONE OR MORE PARTICIPATING BUSINESSES AND OBTAIN PARTICIPATING BUSINESS LOCATION DATA OPERATION 303 the one or more participating businesses provide their business related data via one or more merchant computing systems and/or a user interface device such as a keyboard, such as keyboard 147 of FIG. 1, a mouse, such as mouse 142 of FIG. 1, a touchpad, voice command recognition system, or any other device capable of providing user input to a computing system or for translating user actions into computing system operations, whether available or known at the time of filing or as developed later.

Returning to FIG. 3, in one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for predicting customer flow and arrival times using positional tracking of mobile devices 300 via any network or network system such as network 130 of FIG. 1, and/or any network as discussed herein, and/or as available or known at the time of filing, and/or as later developed.

Returning to FIG. 3, in one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for predicting customer flow and arrival times using positional tracking of mobile devices 300 using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, at REGISTER ONE OR MORE PARTICIPATING BUSINESSES AND OBTAIN PARTICIPATING BUSINESS LOCATION DATA OPERATION 303 the business related data associated with each of the participating businesses is obtained by process for predicting customer flow and arrival times using positional tracking of mobile devices 300 and then the data is stored in a participating business database, such as database 170 of FIG. 1, and/or any database as discussed herein, known at the time of filing, or as developed thereafter.

Returning to FIG. 3, in one embodiment, once one or more participating businesses are registered with, and/or subscribe to, process for predicting customer flow and arrival times using positional tracking of mobile devices 300 and/or various business related data associated with one or more participating businesses is obtained by process for predicting customer flow and arrival times using positional tracking of mobile devices 300 at REGISTER ONE OR MORE PARTICIPATING BUSINESSES AND OBTAIN PARTICIPATING BUSINESS LOCATION DATA OPERATION 303, process flow proceeds to OBTAIN POSITIONAL DATA FOR ONE OR MORE MOBILE DEVICES AT TWO OR MORE DIFFERENT TIMES OPERATION 305.

In one embodiment, at OBTAIN POSITIONAL DATA FOR THE ONE OR MORE MOBILE DEVICES AT TWO OR MORE DIFFERENT TIMES OPERATION 305 the positions of one or more mobile devices associated with one or more consumers are obtained at least two different times.

In one embodiment, at OBTAIN POSITIONAL DATA FOR THE ONE OR MORE MOBILE DEVICES AT TWO OR MORE DIFFERENT TIMES OPERATION 305 the positions of one or more mobile devices, such as mobile devices 100A through 100N of FIG. 1, associated with one or more consumers, are obtained at least two different times.

Returning to FIG. 3, in one embodiment, at OBTAIN POSITIONAL DATA FOR THE ONE OR MORE MOBILE DEVICES AT TWO OR MORE DIFFERENT TIMES OPERATION 305 the one or more mobile devices associated with one or more consumers are registered with process for predicting customer flow and arrival times using positional tracking of mobile devices 300 by any method, means, mechanism or procedure for registering a computing system and/or device, as discussed herein, and/or available or known at the time of filing, and/or as developed after the time of filing.

In one embodiment, at OBTAIN POSITIONAL DATA FOR THE ONE OR MORE MOBILE DEVICES AT TWO OR MORE DIFFERENT TIMES OPERATION 305 the one or more mobile devices associated with one or more consumers are not specifically registered with process for predicting customer flow and arrival times using positional tracking of mobile devices 300, but the positional data of the one or more mobile devices is obtained by process for predicting customer flow and arrival times 300 through one or more mobile communication networks, such as mobile communication network 110 of FIG. 1, and/or providers of one or more mobile communication networks.

Returning to FIG. 3, in one embodiment, at OBTAIN POSITIONAL DATA FOR THE ONE OR MORE MOBILE DEVICES AT TWO OR MORE DIFFERENT TIMES OPERATION 305 the one or more mobile devices are connected by one or more mobile communication networks such as mobile communication network 110 of FIG. 1, and/or any mobile communication network as discussed herein, and/or available or known at the time of filing, and/or as developed after the time of filing.

Returning to FIG. 3, at OBTAIN POSITIONAL DATA FOR THE ONE OR MORE MOBILE DEVICES AT TWO OR MORE DIFFERENT TIMES OPERATION 305 the positions of the one or more mobile devices associated with the one or more consumers are tracked by obtaining data regarding the position of the one or more mobile devices multiple times.

In one embodiment, at OBTAIN POSITIONAL DATA FOR THE ONE OR MORE MOBILE DEVICES AT TWO OR MORE DIFFERENT TIMES OPERATION 305 the positions of one or more mobile devices associated with one or more consumers are obtained at regular defined intervals, such as every second, every few seconds, every minute, every few minutes, etc.

In various embodiments, at OBTAIN POSITIONAL DATA FOR THE ONE OR MORE MOBILE DEVICES AT TWO OR MORE DIFFERENT TIMES OPERATION 305 one or more of the one or more mobile devices are associated with consumers traveling by car, bicycle, train, bus, or any other vehicle in an relatively open environment, such as outside, or in a relatively closed environment, such as a mall, stadium, or shopping center or any building or structure.

In various embodiments, at OBTAIN POSITIONAL DATA FOR THE ONE OR MORE MOBILE DEVICES AT TWO OR MORE DIFFERENT TIMES OPERATION 305 one or more of the one or more mobile devices are associated with consumers traveling by foot in a relatively open environment, such as outside, or in a relatively closed environment, such as a mall, stadium, or shopping center or any building or structure.

In various embodiments, at OBTAIN POSITIONAL DATA FOR THE ONE OR MORE MOBILE DEVICES AT TWO OR MORE DIFFERENT TIMES OPERATION 305 the position of the one or more mobile devices is determined based on analysis of a communication signal emitted by the mobile devices and/or the relay stations used by the mobile devices.

In various embodiments, at OBTAIN POSITIONAL DATA FOR THE ONE OR MORE MOBILE DEVICES AT TWO OR MORE DIFFERENT TIMES OPERATION 305 the position of the one or more mobile devices is determined using a Global Positioning Satellite (GPS) system and/or a GPS capability, such as GPS 101B of FIG. 1, provided with the one or more mobile devices, such as mobile device 101B of FIG. 1.

Returning to FIG. 3, in various embodiments, at OBTAIN POSITIONAL DATA FOR THE ONE OR MORE MOBILE DEVICES AT TWO OR MORE DIFFERENT TIMES OPERATION 305 the position of the one or more mobile devices is provided by the one or more mobile devices themselves via one or more data links.

In various embodiments, at OBTAIN POSITIONAL DATA FOR THE ONE OR MORE MOBILE DEVICES AT TWO OR MORE DIFFERENT TIMES OPERATION 305 the position of the one or more mobile devices is determined, and/or provided, and/or obtained by any method, means, mechanism, or procedure for determining a position of a mobile device as discussed herein, and/or as known in the art at the time of filing, and/or as developed after the time of filing.

In one embodiment, once the positions of one or more mobile devices associated with one or more consumers are obtained at least two different times at OBTAIN POSITIONAL DATA FOR THE ONE OR MORE MOBILE DEVICES AT TWO OR MORE DIFFERENT TIMES OPERATION 305, process flow proceeds to USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307.

In one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 the data regarding the position of the one or more mobile devices at two or more times of OBTAIN POSITIONAL DATA FOR THE ONE OR MORE MOBILE DEVICES AT TWO OR MORE DIFFERENT TIMES OPERATION 305 is used to calculate, and/or update, an estimated direction/path and speed of the one or more consumers.

In one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 the positions of the one or more mobile devices associated with the one or more consumers are tracked by obtaining data regarding the position of the one or more mobile devices at two or more times at OBTAIN POSITIONAL DATA FOR THE ONE OR MORE MOBILE DEVICES AT TWO OR MORE DIFFERENT TIMES OPERATION 305 and using the data to calculate an estimated direction/path and speed of the one or more consumers using one or more processors associated with one or more computing systems, such as CPU 121 of FIG. 1.

Returning to FIG. 3, in one embodiment, at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 the positions of the one or more mobile devices associated with the one or more consumers are tracked by obtaining data regarding the position of the one or more mobile devices at defined intervals at OBTAIN POSITIONAL DATA FOR THE ONE OR MORE MOBILE DEVICES AT TWO OR MORE DIFFERENT TIMES OPERATION 305 such as every second, every few seconds, every minute, every few minutes, etc. and then estimating and updating and/or refining the estimated direction/path and speed of the one or more consumers accordingly using one or more processors associated with one or more computing systems, such as CPU 121 of FIG. 1.

Numerous means, methods, equations, algorithms, procedures and processes are known in the art for calculating an estimated direction/path and speed using two or more positions taken at different times. Consequently, a more detailed discussion of any particular means, methods, equations, algorithms, procedures and processes for calculating an estimated direction/path and speed of one or more consumers using two or more positions taken at different times is omitted here to avoid detracting from the invention.

Returning to FIG. 3, in one embodiment, once the data regarding the position of the one or more mobile devices at two or more times of OBTAIN POSITIONAL DATA FOR THE ONE OR MORE MOBILE DEVICES AT TWO OR MORE DIFFERENT TIMES OPERATION 305 is used to calculate, and/or update, an estimated direction/path and speed of the one or more consumers at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307, process flow proceeds to CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309.

In one embodiment, at CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 and the business related data associated with each of the participating businesses of REGISTER ONE OR MORE PARTICIPATING BUSINESSES AND OBTAIN PARTICIPATING BUSINESS LOCATION DATA OPERATION 303 are analyzed to determine which participating businesses are within a defined distance of the estimated direction/path of the of the one or more mobile devices, and therefore of the one or more consumers associated with the one or more mobile devices.

In one embodiment, at CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 is modified based on data particular to each of the one or more customers, such as data obtained from a customer's calendar application.

In one embodiment, the customer's calendar application is implemented on, accessed by, or at least some of the data is stored on, the mobile device associated with the consumer and is therefore readily accessible. In one embodiment, the customer's calendar application data indicates a time and place of a meeting. In one embodiment this the calendar application data is then used to refine the estimated direction/path and speed for the given customer based on where the customer needs to be at a given time and/or is used to calculate and/or refine a probability that the customer will pass within a defined distance of a particular one of the one or more participating businesses.

In one embodiment, once the estimated direction/path and speed of the one or more consumers calculated at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 and the business related data associated with each of the participating businesses of REGISTER ONE OR MORE PARTICIPATING BUSINESSES AND OBTAIN PARTICIPATING BUSINESS LOCATION DATA OPERATION 303 are analyzed to determine which participating businesses are within a defined distance of the estimated direction/path of the of the one or more mobile devices, and therefore of the one or more consumers associated with the one or more mobile devices at CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309, process flow proceeds to CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a probability that a given consumer of the one or more consumers associated with the one or more mobile devices of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 will utilize a particular participating business is determined.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a probability that a given consumer of the one or more consumers associated with the one or more mobile devices of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 will utilize a particular participating business is determined based, at least in part, on one or more probability of use parameters.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a probability that a given consumer of the one or more consumers associated with the one or more mobile devices of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 will utilize a particular participating business is determined based, at least in part, on a proximity probability of use parameter indicating how close the estimated direction/path of CALCULATE A PROBABILITY THAT ONE OR MORE OF THE ONE OR MORE CONSUMERS ASSOCIATED WITH THE ONE OR MORE MOBILE DEVICES WILL PASS BY A PARTICIPATING BUSINESS LOCATION WITHIN A DEFINED DISTANCE OPERATION 309 will bring a consumer to the given participating business.

In one embodiment, the closer the estimated direction/path of a consumer brings the consumer to the given participating business, the greater the probability that the consumer will utilize the given participating business.

For instance, as a specific illustrative example, if it is determined at CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 that the estimated direction/path of a consumer brings the consumer within 100 yards of a Starbucks coffeehouse, then at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the probability that the consumer will utilize the Starbucks coffeehouse, i.e., purchase a product sold by the Starbucks coffeehouse, would be considered higher than if the estimated direction/path of a consumer brings the consumer within between 100 yards and 1000 yards of a Starbucks coffeehouse, i.e., out of the probable view of the customer.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the probability that one or more of the one or more consumers will utilize a particular participating business is determined based, at least in part, on a proximity probability of use parameter and generalized statistical consumer usage data such as data indicating, on average, what percentage of consumers who pass by a given business type offering products and/or services similar to the given participating business are statistically likely to utilize the given business type.

For instance, as a specific illustrative example, if it is determined that the estimated direction/path of a consumer brings the consumer within 100 yards of a Starbucks coffeehouse, and statistics show that, on average, 5% of consumers who see a Starbucks coffeehouse utilize the Starbucks coffeehouse, then at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 this data is used to help determine the probability that a consumer will utilize the Starbucks coffeehouse.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the probability that one or more of the one or more consumers will utilize a particular participating business is determined based, at least in part, on a proximity probability of use parameter and generalized statistical consumer usage data as modified based on time of the time of day, day of the week, or date data.

For instance, as a specific illustrative example, if it is determined that the estimated direction/path of a consumer brings the consumer within 100 yards of a Starbucks coffeehouse, and statistics show that, on average, 15% of consumers who see a Starbucks coffeehouse utilize the Starbucks coffeehouse between the hours of 6 AM and 10 AM while, on average, only 1% of consumers who see a Starbucks coffeehouse utilize the Starbucks coffeehouse between the hours of 10 AM and 10 PM, then at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 this data, along with data indicating the local time of day, is used to help determine the probability that a consumer will utilize the Starbucks coffeehouse.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the probability that one or more of the one or more consumers will utilize a given participating business is determined based, at least in part, on a proximity probability of use parameter and personalized probability of use parameters.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the personalized probability of use parameters are derived from real time customer input for prospective needs through various mechanisms such as voice, keyboard input, stylus or other means to record the needs of the customer associated with the mobile device, or those in the proximity of such consumer, such as passengers in a car. Such a statement preference of need, for example, “I would love to eat a pizza”, is then included in the set of factors, computing arrival probabilities in merchant establishments in the trajectory of the movement of the mobile device and the associated consumer.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the personalized probability of use parameters are derived from data specific to a given consumer such as, but not limited to, data obtained from a consumer's calendar application.

In one embodiment, data from the consumer's calendar application is used to determine a time and place of a meeting and/or whether the customer has historically utilized the given participating business, or businesses offering products and/or services similar to the products and/or services offered by the given participating business.

In addition, in one embodiment, data from the consumer's calendar application is used to determine if the consumer has time to utilize a given participating business.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 the personalized probability of use parameters are derived from data specific to a given consumer such as, but not limited to, financial transaction data from one or more financial management systems and/or on-line banking systems.

As used herein, the term “financial management system” includes, but is not limited to: any computing system implemented, or web-based, data management system, package, program, module, or application that gathers financial data, including financial transactional data, or has the capability to analyze and categorize at least part of the financial data. Herein, a computing system implemented financial management system can be, but is not limited to, any of the following: an on-line, or web-based, or computing system implemented banking system; an on-line, or web-based, or computing system implemented personal or business financial management system, package, program, module, or application; an on-line, or web-based, or computing system implemented home or business inventory system, package, program, module, or application; an on-line, or web-based, or computing system implemented personal or business asset management system, package, program, module, or application; an on-line, or web-based, or computing system implemented personal or business accounting system, package, program, module, or application; an on-line, or web-based, or computing system implemented personal or business tax preparation system, package, program, module, or application; an on-line, or web-based, or computing system implemented healthcare management system, package, program, module, or application; or any of the numerous an on-line, or web-based, or computing system implemented financial management systems discussed herein, or known to those of skill in the art at the time of filing, or as developed after the time of filing.

Specific examples of computing system implemented financial management systems include, but are not limited to: Quicken™, available from Intuit Inc. of Mountain View, Calif.; Quicken Online™, available from Intuit Inc. of Mountain View, Calif.; Quickbooks™, available from Intuit Inc. of Mountain View, Calif.; Mint.com™, available from Intuit Inc. of Mountain View, Calif.; Microsoft Money™, available from Microsoft, Inc. of Redmond, Wash.; or various other computing system implemented financial management systems discussed herein, or known to those of skill in the art at the time of filing, or as developed after the time of filing.

In one embodiment, all or part of the financial management system is implemented on, or at least part of the financial data is accessible by, the mobile device associated with the consumer. In one embodiment, the financial data is used to determine whether the consumer has historically utilized the given participating business, or businesses offering products and/or services similar to the products and/or services offered by the given participating business.

In one embodiment, the financial data is used to determine whether the consumer has historically shown a preference for a specific one of businesses offering products and/or services similar to the products and/or services offered by the given participating business.

For instance, as a specific illustrative example, an estimated direction/path for a given consumer may indicate that the user will pass within 100 yards of a Peet's coffee shop and within 300 yards of a Starbucks coffeehouse. In addition, in this specific illustrative example, the consumer's calendar data shows the consumer has time to stop for coffee before a scheduled meeting. In addition, in this specific illustrative example, the consumer' financial transactional data shows the consumer historically buys coffee around this time of day. Consequently, absent preference data, the consumer would be assigned a relatively high probability of utilizing a coffee shop and, given that the Peet's coffee shop is three times closer that the Starbucks coffeehouse, the probability of the consumer utilizing the Peet's coffee shop would be calculated as the higher of the two. However, if the consumer' financial transactional data shows the consumer utilizes Starbucks coffeehouses far more frequently than Peet's, then the probability of the consumer utilizing the Peet's coffee shop would be calculated lower and the probability of the consumer utilizing the Starbucks coffeehouse would be calculated as higher. However, if the distance to the Starbucks is too much greater, the probability of the consumer utilizing the Peet's coffee shop could still be calculated as the higher of the two.

As shown in the example above, in one embodiment, the financial data is used in conjunction with the consumers calendar data and/or data indicating the local time of day to determine whether the consumer has historically utilized the particular participating business, or businesses offering products and/or services similar to the products and/or services offered by the particular participating business at the determined time of day, day of the week, or date.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 historical positional data associated with the mobile device and the consumer, in one embodiment as implemented and/or accessed and/or stored on the mobile device, is used to determine whether the consumer has historically utilized the given participating business, or businesses offering products and/or services similar to the products and/or services offered by the given participating business.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 historical positional data associated with the mobile device and the consumer is used in conjunction with the consumers calendar data and/or data indicating the local time of day to determine whether the consumer has historically utilized the particular participating business, or businesses offering products and/or services similar to the products and/or services offered by the particular participating business at the determined time of day, day of the week, or date.

In one embodiment, the probability that one or more of the one or more consumers will utilize a particular participating business is determined based, at least in part, on a proximity probability of use parameter and personalized probability of use parameters.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 any of the probability that one or more of the one or more consumers will utilize a particular participating business is extended to the probability of consumption of certain products within that business. As an example, specific and distinct consumption probabilities can be computed for consumption of specific edibles at Starbucks, knowing the probability of visiting Starbucks, the time of day, the customer's past patterns of consumptions, the weather, the time taken to provide the edible and so on. Thus one embodiment anticipates creating consumption probabilities for Croissants, for Cappuccino, etc at a Starbucks in the trajectory of customers.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 any of the probability of use parameters, or combination of probability of use parameters, discussed above, or any other probability of use parameters defined by process for predicting customer flow and arrival times using positional tracking of mobile devices 300 and/or one or more participating businesses, are used to determine a probability that one or more of the one or more consumers will utilize a particular participating business.

Numerous means, methods, equations, algorithms, procedures and processes are known in the art for calculating probabilities and probability functions based on one or more parameters and/or variables. Consequently, a more detailed discussion of any particular means, methods, equations, algorithms, procedures and processes for determining the probability that one or more of the one or more consumers will utilize a particular participating business using one of more probability of use parameters is omitted here to avoid detracting from the invention.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a probability score is calculated for each participating business/consumer pair that indicates probability that a given consumer will utilize a given participating business in a defined time frame.

In one embodiment, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a threshold probability score is defined for each participating business such that any consumer having a probability score associated with a given participating business that is greater than the defined threshold probability score is deemed probable to utilize the given participating business.

For instance, as a specific illustrative example, a threshold probability score of 34% may be defined for a given Starbucks coffeehouse. Then any consumer having a probability score of 34% or greater is determined at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 to be a probable customer of the given Starbucks coffeehouse.

In various embodiments, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 a given consumer is deemed probable to utilize the given participating business using any other criteria as discussed herein, and/or as known in the art at the time of filing, and/or as developed after the time of filing.

In various embodiments, at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 all tracked consumers are deemed probable to utilize the given participating business, albeit with a wide range of probabilities extending from very low to relatively high. In various embodiments, any desired sub-set of tracked consumers are deemed probable to utilize the given participating business.

In one embodiment, once a probability that a given consumer of the one or more consumers associated with the one or more mobile devices of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 will utilize a particular participating business is determined at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311, process flow proceeds to ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313.

In one embodiment, at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313 the estimated direction/path and speed of USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 for one or more of the one or more consumers of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 is used to calculate, and/or update, estimated arrival times of one or more of the one or more consumers at the given participating business and/or to estimate customer flow (or loading) at the given participating business for a defined timeframe.

As noted above, in one embodiment, the data regarding the position of the one or more mobile devices of OBTAIN POSITIONAL DATA FOR ONE OR MORE MOBILE DEVICES AT TWO OR MORE DIFFERENT TIMES OPERATION 305, and, in some embodiments, various data specific to a given consumer, is used to calculate, and/or update, an estimated direction/path and speed for the one or more consumers at USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307. In one embodiment, at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313 the estimated direction/path and speed for the one or more consumers is used to calculate, and/or update, estimated arrival times of one or more of the one or more consumers at the given participating business.

In one embodiment, at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313 the estimated direction/path and speed for the one or more consumers is used to calculate, and/or update, estimated arrival times of only those consumers deemed probable to utilize the given participating business at the given participating business at CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311.

In one embodiment, at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313 where the consumer is determined to be in a vehicle, traffic data for the estimated direction/path is obtained for one or more sources and traffic data associated with estimated direction/path is used to calculate, and/or update, the estimated arrival times of one or more of the one or more consumers at the given participating business.

In one embodiment, at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313 data representing the number of individual consumers deemed probable to utilize the given participating business and/or the estimated arrival times at the given participating business of the individual consumers deemed probable to utilize the given participating business is aggregated using a probabilistic approach to predict customer flow, i.e., customer loading, for the given business in, or over, a defined time frame.

In one embodiment, once the estimated direction/path and speed of USE THE POSITIONAL DATA FOR THE ONE OR MORE MOBILE DEVICES AT TWO OR MORE DIFFERENT TIMES TO ESTIMATE THE DIRECTION AND SPEED OF THE ASSOCIATED ONE OR MORE CONSUMERS OPERATION 307 for one or more of the one or more consumers of CALCULATE A PROBABILITY THAT ONE OR MORE OF THE ONE OR MORE CONSUMERS ASSOCIATED WITH THE ONE OR MORE MOBILE DEVICES WILL PASS BY A GIVEN PARTICIPATING BUSINESS LOCATION WITHIN A DEFINED DISTANCE OPERATION 309 is used to calculate, and/or update, estimated arrival times of one or more of the one or more consumers at the given participating business and/or to estimate customer flow (or loading) at the given participating business for a defined timeframe at ESTIMATE AN ARRIVAL TIME FOR THE ONE OR MORE OF THE ONE OR MORE CONSUMERS ASSOCIATED WITH THE ONE OR MORE MOBILE DEVICES AT THE GIVEN PARTICIPATING BUSINESS LOCATION WITHIN A DEFINED DISTANCE OPERATION 313, process flow proceeds to PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of consumers deemed probable to utilize the particular participating business of CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 and/or at least part of the data representing the estimated arrival times at the given participating business of consumers deemed probable to utilize the particular participating business of ESTIMATE AN ARRIVAL TIME FOR THE ONE OR MORE OF THE ONE OR MORE CONSUMERS ASSOCIATED WITH THE ONE OR MORE MOBILE DEVICES AT THE SUBSCRIBER BUSINESS LOCATION WITHIN A DEFINED DISTANCE OPERATION 313 is provided to the given participating business.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is aggregated using a probabilistic approach to predict customer flow for the participating business in a defined time frame and then the customer flow, or loading data, is presented to the given participating business as one or more probabilities.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is aggregated and a probability score is calculated for a given customer flow in a defined time frame.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business via a user interface and the given participating business can optionally apply one or more display filters, and/or run one or more reports, using parameters provided by, or chosen by, the given participating business. In this way, the given participating business can create customized displays of the data.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business on a relative, i.e., almost, real time basis.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business via any data link as discussed herein, and/or as known in the art at the time of filing, and/or as developed after the time of filing.

In one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business through one or more merchant computing systems, such as merchant computing system 140 of FIG. 1 and/or any computing system as discussed herein, and/or as known in the art at the time of filing, and/or as developed after the time of filing.

Returning to FIG. 3, in one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business through one or more databases, such as database 170 of FIG. 1 and/or any database as discussed herein, and/or as known in the art at the time of filing, and/or as developed after the time of filing.

Returning to FIG. 3, in one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business through one or more networks, such as network 130 of FIG. 1 and/or any network as discussed herein, and/or as known in the art at the time of filing, and/or as developed after the time of filing.

Returning to FIG. 3, in one embodiment, at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315 at least part of the data representing the number of individual consumers deemed probable to utilize the given participating business and/or at least part of the data representing the estimated arrival times at the given participating business of the individual consumers deemed probable to utilize the given participating business is provided to the given participating business using any method, apparatus, process or mechanism for transferring data from one or more devices, computing systems, server systems, databases, web site/web functions or any devices having a data storage capability to one or more other devices, computing systems, server systems, databases, web site/web functions or any devices having a data storage capability, whether known at the time of filing or as thereafter developed.

In one embodiment, once at least part of the data representing the number of consumers deemed probable to utilize the particular participating business of CALCULATE A PROBABILITY THAT THE ONE OR MORE OF THE ONE OR MORE CONSUMERS ASSOCIATED WITH THE ONE OR MORE MOBILE DEVICES WILL UTILIZE THE GIVEN PARTICIPATING BUSINESS OPERATION 311 and/or at least part of the data representing the estimated arrival times at the given participating business of consumers deemed probable to utilize the particular participating business of ESTIMATE AN ARRIVAL TIME FOR THE ONE OR MORE OF THE ONE OR MORE CONSUMERS ASSOCIATED WITH THE ONE OR MORE MOBILE DEVICES AT THE SUBSCRIBER BUSINESS LOCATION WITHIN A DEFINED DISTANCE OPERATION 313 is provided to the given participating business at PROVIDE THE GIVEN PARTICIPATING BUSINESS ACCESS TO AT LEAST PART OF THE DATA INDICATING THE ESTIMATED ARRIVAL TIME FOR THE ONE OR MORE OF THE ONE OR MORE CONSUMERS AND/OR THE PROBABILITY THAT THE ONE OR MORE OF THE ONE OR MORE CONSUMERS WILL UTILIZE THE GIVEN PARTICIPATING BUSINESS OPERATION 315, process flow proceeds to EXIT OPERATION 330. In one embodiment, at EXIT OPERATION 330 process for predicting customer flow and arrival times using positional tracking of mobile devices 300 is exited to await new data.

In the discussion above, certain aspects of one embodiment include process steps or operations or instructions described herein for illustrative purposes in a particular order or grouping. However, the particular order or grouping shown and discussed herein is illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein does not limit the scope of the invention as claimed below.

Using one embodiment of process for predicting customer flow and arrival times using positional tracking of mobile devices 300, a business owner is provided the information to more accurately predict the flow of customer traffic in relative real time based on actual potential customer positions, predicted customer paths and movement, and a calculated probability of potential customer patronage. Consequently, using process for predicting customer flow and arrival times using positional tracking of mobile devices 300, the business owner can more efficiently and effectively staff the businesses and ensure sufficient inventory is on hand to meet fluctuating customer demand. As a result, both businesses and consumers are directly benefited by use of process for predicting customer flow and arrival times using positional tracking of mobile devices 300.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, and/or protocols. Further, the system and/or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic and/or algorithm-like descriptions and representations are the means used by those of skill in the art to most effectively and efficiently convey the substance of their work to others of skill in the art. These operations, while described functionally or logically, are understood to be implemented by computer programs and/or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “registering”, “distributing”, “calculating”, “estimating”, “using”, “determining”, “generating”, “obtaining”, “identifying”, “analyzing”, “presenting”, “storing”, “saving”, “displaying”, “categorizing”, “providing”, “processing”, “accessing”, “monitoring” etc., refer to the action and processes of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic and/or algorithmic-like form. It should be noted that the process steps and/or operations and instructions of the present invention can be embodied in software, firmware, and/or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar and/or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s and discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A method for predicting customer flow and arrival times using positional tracking of mobile devices comprising:
obtaining location data for one or more participating businesses;
obtaining positional data for one or more mobile devices, each of the one or more mobile devices being associated with a consumer;
using the positional data for the one or more mobile devices to estimate a direction or path and speed of the one or more mobile devices, and therefore an estimated direction or path and speed of the associated consumers;
for one or more of the mobile devices and associated consumers, analyzing data representing the estimated direction or path and speed of the mobile device and associated consumer, and the location data for the one or more participating businesses to determine which of the one or more participating businesses is located within a defined distance of the estimated direction or path of the mobile device and associated consumer;
for one or more of the mobile devices and associated consumers, and one or more of the participating business determined to be located within a defined distance of the estimated direction or path of the mobile device and associated consumer, calculating a probability that the associated consumer will utilize the participating business;
for one or more of the mobile devices and associated consumers, and one or more of the participating business determined to be located within a defined distance of the estimated direction or path of the mobile device and associated consumer, using the data representing the estimated direction or path and speed of the mobile device and associated consumer to estimate an arrival time at the participating business; and
providing at least one the participating businesses data indicating the number of the associated consumers deemed probable to utilize the participating business and the estimated arrival times of the associated consumers deemed probable to utilize the participating business.

2. The method for predicting customer flow and arrival times using positional tracking of mobile devices of claim 1, wherein;
the location data for one or more participating businesses is obtained as part of a registration or subscription to a service for predicting customer flow and arrival times using positional tracking of mobile devices.

3. The method for predicting customer flow and arrival times using positional tracking of mobile devices of claim 1, wherein;
in addition to the location data for one or more participating businesses, one or more of the one or more participating businesses provide additional business related data selected from the group of business related data consisting of:
the participating business name;
products or services provided by the participating business;
the participating business hours of operation; and
logistical data associated with the participating business such as parking availability, and seating capacity.

4. The method for predicting customer flow and arrival times using positional tracking of mobile devices of claim 1, wherein;
the positional data for one or more mobile devices is obtained at least twice.

5. The method for predicting customer flow and arrival times using positional tracking of mobile devices of claim 1, wherein;
the positional data for one or more mobile devices is obtained at regular intervals.

6. The method for predicting customer flow and arrival times using positional tracking of mobile devices of claim 5, wherein;
the positional data for one or more mobile devices obtained at regular intervals is used to update the estimated direction or path and speed of the one or more mobile devices, and therefore an estimated direction or path and speed of the associated consumers, at regular intervals.

7. The method for predicting customer flow and arrival times using positional tracking of mobile devices of claim 1, wherein;
calendar data and scheduled meeting locations associated with an associated consumer is used to modify the estimated direction or path and speed of the associated consumer.

8. The method for predicting customer flow and arrival times using positional tracking of mobile devices of claim 1, wherein;
how close the estimated direction or path and speed of an associated consumer brings the associated consumer to a participating business is used as at least one probability of use parameter to calculate the probability that the associated consumer will utilize a participating business.

9. The method for predicting customer flow and arrival times using positional tracking of mobile devices of claim 1, wherein;
calendar data and the location of scheduled meetings associated with an associated consumer is used as at least one probability of use parameter to calculate the probability that the associated consumer will utilize a participating business.

10. The method for predicting customer flow and arrival times using positional tracking of mobile devices of claim 1, wherein;
calendar data and the time scheduled meetings associated with an associated consumer is used as at least one probability of use parameter to calculate the probability that the associated consumer will utilize a participating business.

11. The method for predicting customer flow and arrival times using positional tracking of mobile devices of claim 1, wherein;
financial data and historical financial transactions associated with the associated consumers is used as at least one probability of use parameter to calculate the probability that the associated consumer will utilize a participating business.

12. The method for predicting customer flow and arrival times using positional tracking of mobile devices of claim 1, wherein;
at least part of the data indicating the number of the associated consumers deemed probable to utilize the participating business and the estimated arrival times of the associated consumers deemed probable to utilize the participating business is provided to at least one the participating businesses as a probability function display.

13. A computing system implemented process for predicting customer flow and arrival times using positional tracking of mobile devices comprising:
using one or more processors associated with one or more computing systems to obtain location data for one or more participating businesses;
using one or more processors associated with one or more computing systems to obtain positional data for one or more mobile devices, each of the one or more mobile devices being associated with a consumer;
using one or more processors associated with one or more computing systems to estimate a direction or path and speed of the one or more mobile devices, and therefore an estimated direction or path and speed of the associated consumers, using the positional data for the one or more mobile devices;
for one or more of the mobile devices and associated consumers, using one or more processors associated with one or more computing systems to analyze data representing the estimated direction or path and speed of the mobile device and associated consumer, and the location data for the one or more participating businesses to determine which of the one or more participating businesses is located within a defined distance of the estimated direction or path of the mobile device and associated consumer;
for one or more of the mobile devices and associated consumers, and one or more of the participating business determined to be located within a defined distance of the estimated direction or path of the mobile device and associated consumer, using one or more processors associated with one or more computing systems to calculate a probability that the associated consumer will utilize the participating business;
for one or more of the mobile devices and associated consumers, and one or more of the participating business determined to be located within a defined distance of the estimated direction or path of the mobile device and associated consumer, using one or more processors associated with one or more computing systems and the data representing the estimated direction or path and speed of the mobile device and associated consumer to estimate an arrival time at the participating business; and
using one or more processors associated with one or more computing systems to provide at least one the participating businesses data indicating the number of the associated consumers deemed probable to utilize the participating business and the estimated arrival times of the associated consumers deemed probable to utilize the participating business.

14. The computing system implemented process for predicting customer flow and arrival times using positional tracking of mobile devices of claim 13, wherein;
the location data for one or more participating businesses is obtained as part of a registration or subscription to a service for predicting customer flow and arrival times using positional tracking of mobile devices.

15. The computing system implemented process for predicting customer flow and arrival times using positional tracking of mobile devices of claim 13, wherein;
in addition to the location data for one or more participating businesses, one or more of the one or more participating businesses provide additional business related data selected from the group of business related data consisting of:
the participating business name;
products or services provided by the participating business;
the participating business hours of operation; and
logistical data associated with the participating business such as parking availability, and seating capacity.

16. The computing system implemented process for predicting customer flow and arrival times using positional tracking of mobile devices of claim 13, wherein;
the positional data for one or more mobile devices is obtained at least twice.

17. The computing system implemented process for predicting customer flow and arrival times using positional tracking of mobile devices of claim 13, wherein;
the positional data for one or more mobile devices is obtained at regular intervals.

18. The computing system implemented process for predicting customer flow and arrival times using positional tracking of mobile devices of claim 17, wherein;
the positional data for one or more mobile devices obtained at regular intervals is used to update the estimated direction or path and speed of the one or more mobile devices, and therefore an estimated direction or path and speed of the associated consumers, at regular intervals.

19. The computing system implemented process for predicting customer flow and arrival times using positional tracking of mobile devices of claim 13, wherein;
calendar data and scheduled meeting locations associated with an associated consumer is used to modify the estimated direction or path and speed of the associated consumer.

20. The computing system implemented process for predicting customer flow and arrival times using positional tracking of mobile devices of claim 13, wherein;
how close the estimated direction or path and speed of an associated consumer brings the associated consumer to a participating business is used as at least one probability of use parameter to calculate the probability that the associated consumer will utilize a participating business.

21. The computing system implemented process for predicting customer flow and arrival times using positional tracking of mobile devices of claim 13, wherein;
calendar data and the location of scheduled meetings associated with an associated consumer is used as at least one probability of use parameter to calculate the probability that the associated consumer will utilize a participating business.

22. The computing system implemented process for predicting customer flow and arrival times using positional tracking of mobile devices of claim 13, wherein;
calendar data and the time scheduled meetings associated with an associated consumer is used as at least one probability of use parameter to calculate the probability that the associated consumer will utilize a participating business.

23. The computing system implemented process for predicting customer flow and arrival times using positional tracking of mobile devices of claim 13, wherein;
financial data and historical financial transactions associated with the associated consumers is used as at least one probability of use parameter to calculate the probability that the associated consumer will utilize a participating business.

24. The computing system implemented process for predicting customer flow and arrival times using positional tracking of mobile devices of claim 13, wherein;
at least part of the data indicating the number of the associated consumers deemed probable to utilize the participating business and the estimated arrival times of the associated consumers deemed probable to utilize the participating business is provided to at least one the participating businesses as a probability function display.

25. A system for predicting customer flow and arrival times using positional tracking of mobile devices comprising:
one or more participating businesses;
one or more mobile devices, each of the one or more mobile devices being associated with a consumer; and
one or more processors associated with one or more computing systems, the one or more computing systems implementing at least part of a process for predicting customer flow and arrival times using positional tracking of mobile devices, the process for predicting customer flow and arrival times using positional tracking of mobile devices including:
using the one or more processors associated with the one or more computing systems to obtain location data for the one or more participating businesses;
using the one or more processors associated with the one or more computing systems to obtain positional data for the one or more mobile devices;
using the one or more processors associated with the one or more computing systems to estimate a direction or path and speed of the one or more mobile devices, and therefore an estimated direction or path and speed of the associated consumers, using the positional data for the one or more mobile devices;
for one or more of the mobile devices and associated consumers, using the one or more processors associated with the one or more computing systems to analyze data representing the estimated direction or path and speed of the mobile device and associated consumer, and the location data for the one or more participating businesses to determine which of the one or more participating businesses is located within a defined distance of the estimated direction or path of the mobile device and associated consumer;
for one or more of the mobile devices and associated consumers, and one or more of the participating business determined to be located within a defined distance of the estimated direction or path of the mobile device and associated consumer, using the one or more processors associated with the one or more computing systems to calculate a probability that the associated consumer will utilize the participating business;
for one or more of the mobile devices and associated consumers, and one or more of the participating business determined to be located within a defined distance of the estimated direction or path of the mobile device and associated consumer, using the one or more processors associated with the one or more computing systems and the data representing the estimated direction or path and speed of the mobile device and associated consumer to estimate an arrival time at the participating business; and
using the one or more processors associated with the one or more computing systems to provide at least one the participating businesses data indicating the number of the associated consumers deemed probable to utilize the participating business and the estimated arrival times of the associated consumers deemed probable to utilize the participating business.

26. The system for predicting customer flow and arrival times using positional tracking of mobile devices of claim 25, wherein;
the location data for one or more participating businesses is obtained as part of a registration or subscription to a service for predicting customer flow and arrival times using positional tracking of mobile devices.

27. The system for predicting customer flow and arrival times using positional tracking of mobile devices of claim 25, wherein;
in addition to the location data for one or more participating businesses, one or more of the one or more participating businesses provide additional business related data selected from the group of business related data consisting of:
the participating business name;
products or services provided by the participating business;
the participating business hours of operation; and
logistical data associated with the participating business such as parking availability, and seating capacity.

28. The system for predicting customer flow and arrival times using positional tracking of mobile devices of claim 25, wherein;
the positional data for one or more mobile devices is obtained at least twice.

29. The system for predicting customer flow and arrival times using positional tracking of mobile devices of claim 25, wherein;
the positional data for one or more mobile devices is obtained at regular intervals.

30. The system for predicting customer flow and arrival times using positional tracking of mobile devices of claim 29, wherein;
the positional data for one or more mobile devices obtained at regular intervals is used to update the estimated direction or path and speed of the one or more mobile devices, and therefore an estimated direction or path and speed of the associated consumers, at regular intervals.

31. The system for predicting customer flow and arrival times using positional tracking of mobile devices of claim 25, wherein;
calendar data and scheduled meeting locations associated with an associated consumer is used to modify the estimated direction or path and speed of the associated consumer.

32. The system for predicting customer flow and arrival times using positional tracking of mobile devices of claim 25, wherein;
how close the estimated direction or path and speed of an associated consumer brings the associated consumer to a participating business is used as at least one probability of use parameter to calculate the probability that the associated consumer will utilize a participating business.

33. The system for predicting customer flow and arrival times using positional tracking of mobile devices of claim 25, wherein;
calendar data and the location of scheduled meetings associated with an associated consumer is used as at least one probability of use parameter to calculate the probability that the associated consumer will utilize a participating business.

34. The system for predicting customer flow and arrival times using positional tracking of mobile devices of claim 25, wherein;
calendar data and the time scheduled meetings associated with an associated consumer is used as at least one probability of use parameter to calculate the probability that the associated consumer will utilize a participating business.

35. The system for predicting customer flow and arrival times using positional tracking of mobile devices of claim 25, wherein;
financial data and historical financial transactions associated with the associated consumers is used as at least one probability of use parameter to calculate the probability that the associated consumer will utilize a participating business.

36. The system for predicting customer flow and arrival times using positional tracking of mobile devices of claim 25, wherein;
at least part of the data indicating the number of the associated consumers deemed probable to utilize the participating business and the estimated arrival times of the associated consumers deemed probable to utilize the participating business is provided to at least one the participating businesses as a probability function display.
